(19) United States
(12) Patent Application Publication
(10) Pub. No.: US 2025/0130997 A1
(43) Pub. Date: Apr. 24, 2025

(54) JOINS IN DATABASE QUERIES

(71) Applicant: INTERNATIONAL BUSINESS MACHINES CORPORATION, Armonk, NY (US)

(72) Inventors: Jun Hui LIU, Xi'an (CN); Ying Qi PAN, Beijing (CN); Hai Jun SHEN, Tianjin (CN); Ya Qiong LIU, Beijing (CN); Lei CUI, Beijing (CN)

(21) Appl. No.: 18/491,081

(22) Filed: Oct. 20, 2023

(51) Int. Cl. G06F 16/2453; G06F 16/22

(52) U.S. Cl. CPC G06F 16/24544; G06F 16/2282

(57) ABSTRACT

Computer implemented methods, systems, and computer program products include program code executing on a processor(s) that obtain a query comprising a JOIN statement that references two or more tables in the one or more remote databases. The program code determines, for each table of the two or more tables, whether executing the JOIN statement utilizes system resources above a pre-defined allotment. Based on determining, for at least one table the program code generates a filter for the at least one table based on an intersection between predicates in the query. The program code applies the filer to the at least one table to fetch results for the query and exclude unrelated data from the fetching.

### BACKGROUND

The present invention relates generally to the field of query optimization in databases and, specifically, to improving the performance of JOIN statements in certain scenarios.

In structured query language (SQL), a programming language for storing and processing information in a relational database, JOIN (referred to herein as a JOIN statement) is a command clause that combines records from two or more tables in a database. Specifically, a JOIN combines data in fields from two tables by using values common to each table. In a query, JOIN clause is considered complex because simple queries retrieve data from a single table while a JOIN retrieves data from multiple tables. There are four different types of JOINs: inner JOIN, left outer JOIN, right outer JOIN, and full outer JOIN. An inner JOIN combines two tables based on a shared key (i.e., each table has a column called “userid”). A left JOIN returns all rows from the first table and only the rows in the second table that match. A right JOIN returns all rows the second table, and only the rows in the first table that match. A full outer JOIN combines the left and right joins to return all rows from both tables provided there is at least one match.

### SUMMARY

Shortcomings of the prior art are overcome, and additional advantages are provided through the provision of a computer-implemented method for planning and executing a query with a JOIN statement in one or more remote databases. The method can include: obtaining, by one or more processors, the query comprising the JOIN statement, wherein the JOIN statement references two or more tables in the one or more remote databases; determining, by the one or more processors, for each table of the two or more tables, whether executing the JOIN statement utilizes system resources above a pre-defined allotment; based on determining, for at least one table of the two or more tables, that executing the JOIN statement utilizes the system resources above the pre-defined allotment, generating, by the one or more processors, a filter for the at least one table based on an intersection between predicates in the query; and applying, by the one or more processors, the filter, to the at least one table to fetch results for the query and exclude unrelated data from the fetching, wherein the results comprise a filtered dataset.

Shortcomings of the prior art are overcome, and additional advantages are provided through the provision of a computer program product for planning and executing a query with a JOIN statement in one or more remote databases. The computer program product comprises a storage medium readable by a one or more processors and storing instructions for execution by the one or more processors for performing a method. The method includes, for instance: obtaining, by the one or more processors, the query comprising the JOIN statement, wherein the JOIN statement references two or more tables in the one or more remote databases; determining, by the one or more processors, for each table of the two or more tables, whether executing the JOIN statement utilizes system resources above a pre-defined allotment; based on determining, for at least one table of the two or more tables, that executing the JOIN statement utilizes the system resources above the pre-defined allotment, generating, by the one or more processors, a filter for the at least one table based on an intersection between predicates in the query; and applying, by the one or more processors, the filter, to the at least one table to fetch results for the query and exclude unrelated data from the fetching, wherein the results comprise a filtered dataset.

Shortcomings of the prior art are overcome, and additional advantages are provided through the provision of a system for planning and executing a query with a JOIN statement in one or more remote databases. The system includes: a memory, one or more processors in communication with the memory, and program instructions executable by the one or more processors via the memory to perform a method. The method includes, for instance: obtaining, by the one or more processors, the query comprising the JOIN statement, wherein the JOIN statement references two or more tables in the one or more remote databases; determining, by the one or more processors, for each table of the two or more tables, whether executing the JOIN statement utilizes system resources above a pre-defined allotment; based on determining, for at least one table of the two or more tables, that executing the JOIN statement utilizes the system resources above the pre-defined allotment, generating, by the one or more processors, a filter for the at least one table based on an intersection between predicates in the query; and applying, by the one or more processors, the filter, to the at least one table to fetch results for the query and exclude unrelated data from the fetching, wherein the results comprise a filtered dataset.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is an overview of various aspects performed by the program code (executing on one or more processors) and some elements of a technical infrastructure in some embodiments of the present disclosure;

FIG. 3 is a representation of a local database host fetching data from a remote table, which is performed in accordance with certain aspects of some embodiments of the present disclosure.

FIG. 4 is an illustration of a filter generated and utilized in some examples herein to fetch relevant data responsive to a query;

FIG. 5 is an illustration of a filter generated and utilized in some examples herein to fetch relevant data responsive to a query; and

FIG. 6 is an overview of some elements of a technical infrastructure in some embodiments of the present disclosure.

### DETAILED DESCRIPTION

The examples herein include computer-implemented methods, computer program products, and computer systems where program code executing on one or more processors executes JOIN statements in a manner that improves the performance of the operations, particularly in complex computing environments, including but not limited to hybrid cloud database system, other distributed database systems, and shared or enterprise computing environments. In these complex computing environments improving performance of query in join scenario between tables is important at least because the performance of the system can be negatively impacted by inefficient query processing, which can reduce the speed of network transmission, dataset translation, and join calculation efficiency, etc. One area where join performance can impact system performance is when a query is executed that performs a JOIN statement between tables in different databases. In existing database systems, a JOIN between tables from different databases introduces factors that can negatively impact system performance. First, in current approaches, this type of JOIN will fetch datasets from remote tables respectively, which can add network transmission (traffic) and reduce the performance. Second, current approaches add dataset translation in a wrapper, also adding to the workload. Third, current approaches involve calculating join results locally with datasets fetched from remote data sources, which adds to both memory and central processing unit (CPU) usage. When a processor executes a JOIN statement that joins tables from different database, the processor will fetch all datasets from remote data sources, which results in bad performance. The indicators of this bad performance include more network latency (e.g., based on more dataset transmissions) and more normalization and calculations for the fetched datasets (e.g., based on fetching more datasets remotely and performing the normalizations and calculations locally). To counter these issues, elements of the examples herein include: 1) improved database statistics collection; 2) query pre-processing with a compression ratio; 3) enhanced statistics calculation; and/or 4) simplified prediction and column filtering.

The computer-implemented methods, computer program products, and computer systems herein provide improved JOIN statement performance in database queries, which is particularly impactful in complex environments where the JOIN statement is performed on tables in different databases. As will be discussed herein, in some examples, program code obtains statistics of each of the tables called in the JOIN statement. The statistics obtained by the program code can include, for all columns in the tables in the JOIN statement: distribution of the column, column average length, column cardinality, and/or table cardinality. The program code can determine how to fetch related dataset(s) from each remote table utilizing the compression ratio for the columns (for which the program code obtained the statistics), the cardinality of table, and/or the capability of related assets (e.g., network throughout, local memory, CPU, etc.). The program code can fetch the dataset(s) of predicate (i.e., a condition expression that evaluates to a Boolean value, either true or false) columns from remote tables, and join them locally. The program code can fetch the dataset(s) from remote tables and utilize the results fetched initially (the predicate columns) as a filter to remove unrelated dataset(s). Thus, the quantity of data that the program code fetches from a remote location (that is transmitted to a local resource and translated by a local resource), is reduced. The program code combines the filtered results and the initial results as the query result.

Embodiments of the present invention are inextricably tied to computing. The examples herein provide a computer-based solution to an issue in computing. Many applications and products rely on executing queries in databases. How these queries pull data from various database within computing systems, such as distributed systems, can be managed by middleware, including database management software. As computing systems grow and enterprise, hybrid, and cloud or other distributed computing environments become more prevalent, inefficient queries can stress the system as a whole and can compromise the performance of the system. Executing JOIN statements in complex computing systems using current approaches can cause network latency and can stress local resources (e.g., instead of being able to distribute the work to available resources). The examples herein are inextricably tied to computing because they address this issue, which is a computing issue, using an approach that manages the processing of these queries, which are also inextricably tied to computing.

The examples herein are directed to a practical application and provide significantly more than existing approaches to executing queries that include JOIN statements in complex computing environments (which include hybrid cloud environments). The examples herein are directed to a practical application at least because the examples herein address a particular issue: JOIN statements performed in complex computing environments negatively impacting overall system performance, with a specific approach. The computer-implemented methods, computer program products, and computer systems described herein provide an approach to executing JOIN statements in a complex computing environment where program code executing on one or more processors generates related filters with statistics of tables and fetches the requested (by the JOIN statement) dataset utilizing these filters to improve query performance. The examples herein provide significantly more than existing approaches at least because there are various advantages to implementing aspects of these examples. For example, program code in some examples estimates and filters an unrelated dataset intelligently with statements related statistics, reduces the dataset size of a querying result fetched from remote data sources, reduces network latency between data virtualization master nodes and remote data sources, and/or reduces dataset size so there is less data to translate between a data virtualization database format and a remote data source format. These aspects enable more efficient performance of JOIN statements and hence, improve the performance of the computer system. Some existing approaches to improving performance of JOIN statements in complex computing systems include rewriting query statements (before execution) to push the JOIN statement down in the order, but this rewriting of the query is not done intelligently and thus does not reduce the unrelated dataset as much as possible while the examples herein do reduce the unrelated dataset as much as possible. Other approaches rewrite the statement but do not utilize related statistics and without this aspect, the rewrite of the statement cannot be executed with predictable efficiency.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

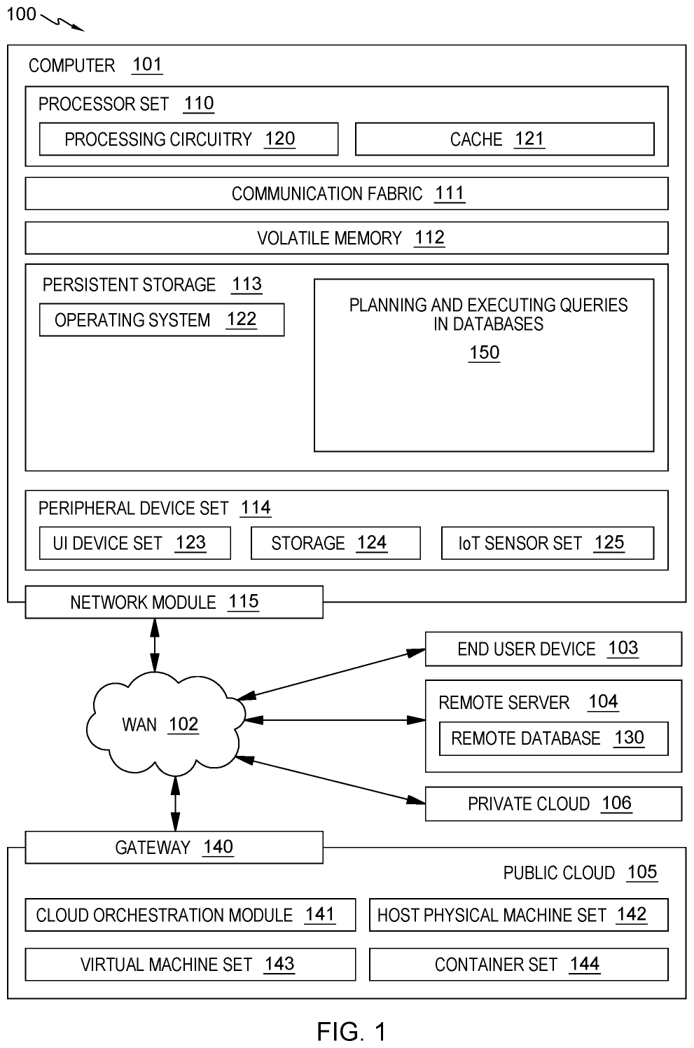

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for planning and executing queries in one or more databases 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

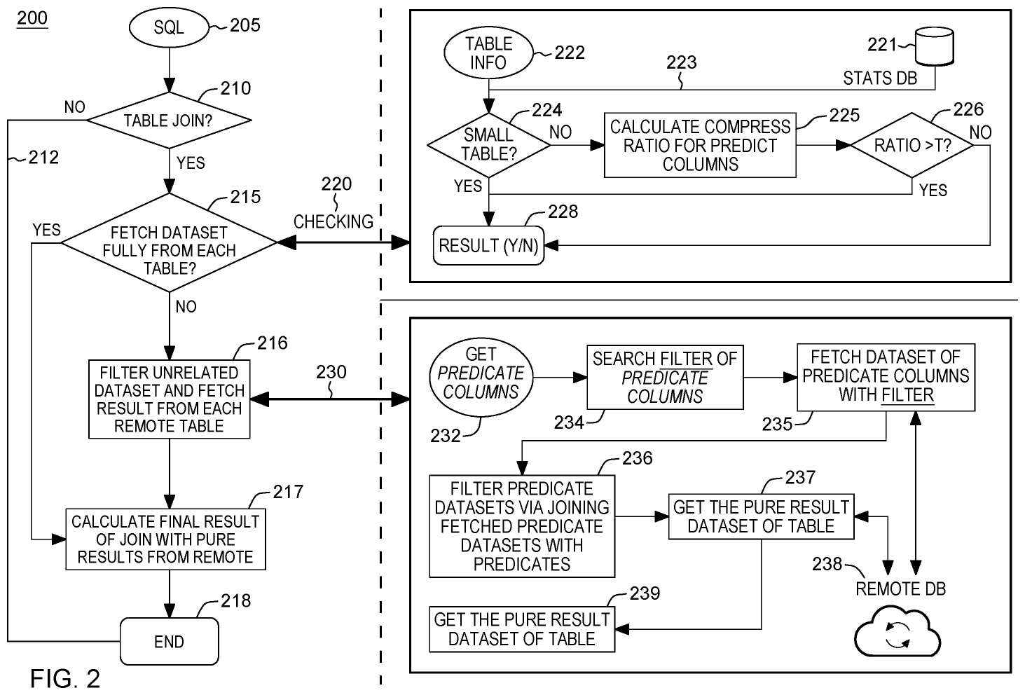

FIG. 2 is a workflow 200 that illustrates various aspects of some examples herein. FIG. 2 provides a general overview of various aspects that will be detailed further herein. As illustrated in FIG. 2, program code executing on one or more processors obtains a SQL query (205). The program code determines if there is a JOIN statement (joining two or more tables) in the SQL query (210). If there is no JOIN statement, the program code continues processing the query according to current approaches (212) and the querying process can terminate (218). If there is a JOIN statement in the query, the program code determines whether to fetch the dataset fully from each table (in the JOIN statement) (215). The program code performs a check or analysis in making this determination (220) and the result of this analysis is a Y/N decision by the program code as to whether to fetch the full dataset from each remote table or whether to utilize additional aspect to minimize the amount of data fetched from a remote resource to a local resource (and subsequently translated by the local resource). To that end, the program code obtains table information (222) to determine if (for each table in the JOIN statement) the table is a small table (224).

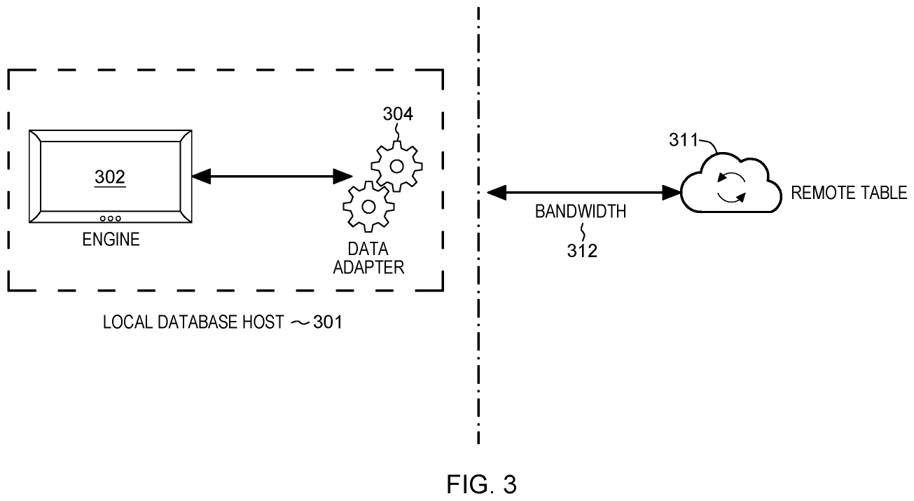

FIG. 3 illustrates how a local database host obtains data from a remote table, when performing a query. FIG. 3 is relevant to the program code executing on one or more processors in the examples herein checking the table size of a table to determine if the table size is small (e.g., FIG. 2, 224). The program code performs this check on the tables referenced in the JOIN statement to determine how to query each table to improve the efficiency of the query (specifically of the JOIN statement). As illustrated in FIG. 3, a local database engine 302 on a local database host 301 utilizes a data adapter 304 to translate the date obtained (by a query) from a remote table 311 to a format usable by the local database host 301. Generally, a data adapter 304 retrieves data from a data source (e.g., remote table 311) and populate tables within a dataset (which is local in this example). The data adapter 304 can also resolve changes made to the dataset back to the data source (e.g., remote table 311). In a non-limiting example, the database engine 302 is the engine in a PureData (PDA) system. The database engine 302 integrates database, server, and storage. To obtain a dataset from the remote table 311, the program code utilizes some of the system's bandwidth 312. Additionally, processing (e.g., translating) the dataset by the data adapter 304 can be a strain on local resources. Thus, so that resources within the system are utilized efficiently, in advance of fetching from a remote table for a JOIN statement, the program code determines if (for each table in the JOIN statement) the table is a small table (FIG. 2, 224) to begin evaluating how to obtain data from the remote database in a manner that does not negatively impact system performance.

The program code checks whether the remote tables (referenced to the JOIN operator) are small table or not to improve the performance of the query (224). To make this determination, in some examples, the program code takes an average length of each column in both a select list and a predicate list, table cardinality (uniqueness of data in a specific column of a table), memory usage of local host, and bandwidth, as function parameters. Equation 1 below illustrates this calculation. Whether a table is considered small or not can be based on pre-defined thresholds based on the resources of the complex system in which the program code executed the query. The program code pulls parameters (e.g., statistics) and utilizes the statistics from a statistical database 221 to determine whether the table is a small table (223).

$$f ( … ) = f ( c o l {s}_{s i z e} ) * f ( {memory}_{u s a g e} ) * f ( bandwidth ) * σ \qquad ( Equation l )$$

If the program code determines that a given table is small, the program code can utilize this criterion to determine whether to obtain results from the table (228). Obtaining results from a small table does not impact the performance of the system in the same manner as obtaining results from a table that is not small (e.g., because the program code utilizes less bandwidth (FIG. 3, 312) to transmit the data and the data adapter 304 utilizes fewer local resources (memory, CPU) to translate the data). When the program code determines that the table is not small (based on pre-defined criteria), the program code calculates a compression ratio for the predicted columns (225).

The program code utilizes cardinality and column distribution to calculate the compression ratio of the table. The program code can utilize Equation 2 below to calculate the total size of the columns in the select list (in the JOIN statement in the query). In Equation 2, colCard is the cardinality of a column and colAvgLen is an average length of a column.

$${\sum }_{i = 1}^{n} ( c o l A v g L e {n}_{i} * {colCard}_{i} ) \qquad ( Equation 2 )$$

The program code can then determine the total size of the columns in the predicate list (in the query), for example, utilizing Equation 3 below. In Equation 3, colAvgLen is an average length of a column and colCard: the cardinality of the column.

$${\sum }_{i = 1}^{m} ( colA v g L e {n}_{j} * {colCard}_{j} ) \qquad ( Equation 3 )$$

The program code can calculate the total size of columns in the predicate list using Equation 4 below. In Equation 4, colAvgLen is an average length of column and colCard is the cardinality which needs to be fetched in a cross range of predicate columns in the query.

$${colCard}_{j} = {\sum }_{k = min}^{max} v a l C o u n {t}_{k} \qquad ( Equation 4 )$$

Based on the results of Equations 2-4, the program code can set a compression ratio using Equation 5, below and compare it to a threshold (T) (e.g., FIG. 2, 226).

$$Ratio = \frac{preOptSize}{selSize + preSize} \leq {T}_{thresh \_ hold} \qquad ( Equation 5 )$$

Once the program code has calculated the compression ratio for a table, the program code compares the ratio to a threshold (T), which can be predetermined. If the ratio is greater than the threshold, the program code will obtain query results from the table using the optimized method described herein, and if it is less than the threshold, the program code can obtain results from the table without utilizing this method (without adversely impacting the performance of the system) (228). Thus, based on the check (220), the program code determines whether to fetch each dataset fully from each table in the JOIN statement (215). For tables which the program code determines can be remotely queried, either because they are small (224) or because the compression ratio is great than the threshold (226), for these tables (e.g., the columns in these tables), the program code calculates a final results set of the query with (pure) results from the remote database (which includes the table that was analyzed or checked by the program code) (217). However, when the program code determines that fetching a dataset for a given table would adversely affect system performance and therefore determines that the program code should not fetch this dataset fully from the table, either because the table is not small (224) or because the compression ratio is smaller than or equal to the threshold (226), the program code filters an unrelated dataset and fetch result from each remote table (216). By calculating this filter, the program code removes unrelated data in the query.

To filter these elements, the program code applies a process to generate and apply these filters (230). The program code obtains predicate columns (232). The program code generates a search filter of the predicate columns (234). The program code fetches from a remote database 238, a dataset of predicate columns with the filter (235). The program code filters predicate datasets by joining fetched predicate datasets with the predicates (236). The program code accessing the remote database 238 to fetch the query dataset with the filtered dataset (237). The program code gets the (pure) results dataset of the table (239). The program code calculates a final result set of the SQL query 205 (pure) results, whether obtained through (fully and/or partially) the optimized method or not (217) and the execution of the query terminates (218) based on the program code having returned the results.

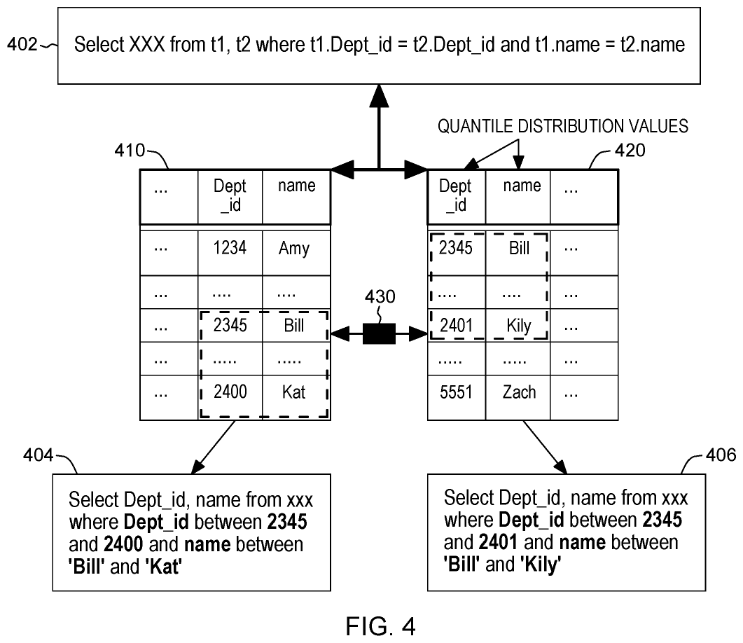

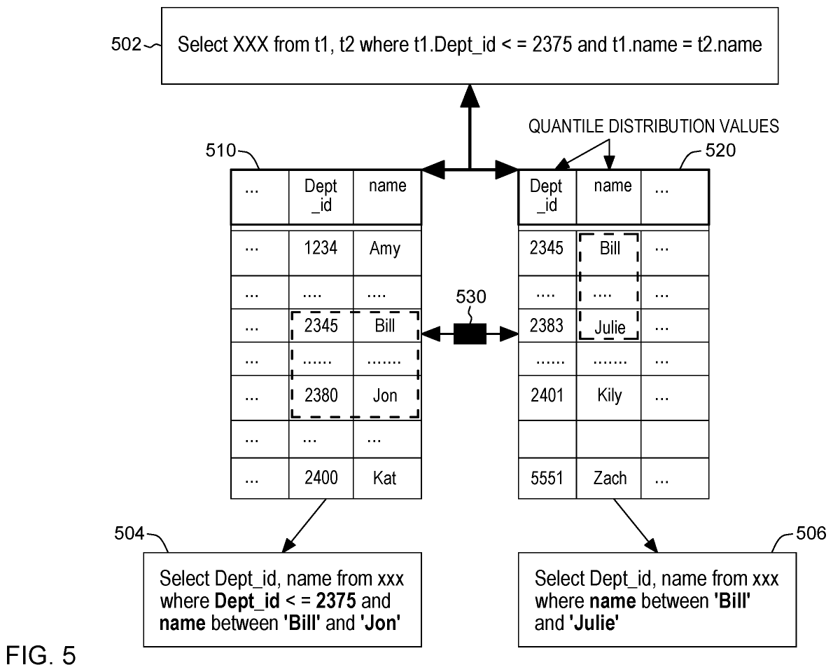

FIGS. 4-5 illustrate how the program code filters the dataset obtained from the remote databases using predicate columns. By applying the filter, the program code obtains less data from the remote sources, which minimizes bandwidth for results transmission and local resource use for data translation. FIG. 4 illustrates an example where there are no constants in the predicate list in the query and FIG. 5 illustrates an example where there are constant predicates, in this non-limiting example, range-related predicates.

FIG. 4 illustrates a scenario where there are no constant predicates in the predicate list. The SQL query 402 includes the syntax “Select XXX from t1, t2 where t1.Dept_id=t2.Dept_id and t1.name=t2.name.” When program code executes the statement, it would select XXX from table t1 410 and table t2 420 where the department identifier in table t1 410 is equal to the department identifier in table t2 420 and the name in table t1 410 is equal to the name in table t2 420. The program code filters with a query or data set that is an intersection 430 between ranges of all predicates via quantile distribution. The range selected in table t1 410 is represented by the SQL statement 404: “Select Dept_Id, name from xxx where Dept_id between 2345 and 2400 and name between ‘Bill’ and ‘Kat’.” If executed, the program code would select the department identifier and name from xxx where that department identifier is between 2345 and 2400 and the name is between Bill and Kat. The range selected in table t2 420 can be represented by the SQL statement 506: “Select Dept_Id, name from xxx where Dept_id between 2345 and 2401 and name between ‘Bill’ and ‘Kily’.” If executed by the program code, this statement would select department identifier and name from xxx where the department identifier is between 2345 and 2401 and the name is between Billy and Kily. This intersection 340 solution (e.g., intersection between ranges of all predicates via quantile distributions) used as a filter is represented below.

$$P {1}_{min}^{max} ∩ P {2}_{min}^{max} … ⋂ {Pn}_{min}^{max}$$

FIG. 5 illustrates a scenario where the predicates have constant predicates, such as range related predicates. The SQL query 502 includes the syntax “Select XXX from t1, t2 where t1.Dept_id<=2375 and t1.name=t2.name.” Meaning to select XXX from table t1 and table t2 where the department identifier in table 1 is less than or equal to 2375 and the name field in table t1 equals the name field in table t2. Table t1 510 and table t2 520 are both illustrated. The program code filters this statement (e.g., the results of the statement) with an intersection between ranges of all the predicates 530. The selected portion of table t1 510 can be represented by the statement 504 is “Select Dept_Id, name from xxx where Dept_id<=2375 and name between ‘Bill’ and ‘Jon’.” Thus, the program code selects the department identifier and name, from xxx where the department identifier is less than or equal to 2375 and the name is between Bill and Jon. On table 2 t2 520 the select statement 506 is “Select Dept_Id, name from xxx where name between ‘Bill’ and ‘Julie’.” Thus, by executing this statement the program code would select the department identifier and name from xxx where the name is between Bill and Julie. The program code filters with the intersection between rangers of all the predicates via quantile distributions, as illustrated below.

$$P {1}_{min}^{max} ∩ P {2}_{min}^{max} … ⋂ {P}_{const}$$

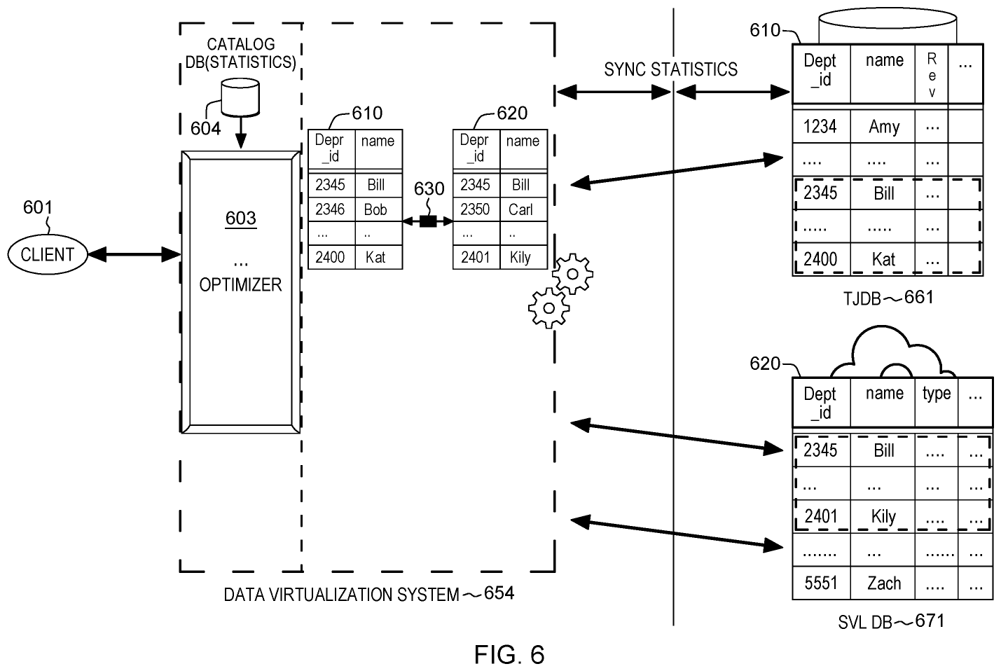

Although two tables are used as an example in FIGS. 4-5, the examples herein can be applied to multiple tables. FIG. 6 uses an example of two tables also, for illustrative purposes only. FIG. 6 illustrates aspects of the present query execution method when a JOIN statement without constant predicates is included in the query.

In FIG. 6, a database engine or query optimizer 603 obtains a query (that includes a JOIN statement) from a client 601. The query, which is an example used throughout this figure and provided not to suggest any limitations but to illustrate this example is: “Select tj.dept_id, tj. name, type, Rev, from nk_tj as tj from nk_svl as svl on tj. Dept_id=svl.dept_id and tj.name=svl.name.” The SELECT statement includes columns from tables in two databases, TJ DB 661 and SVL DB 671. The program code can obtain database statistics from a (e.g., local) catalog database 604 to determine whether to utilize the optimized method (e.g., FIG. 2, 220). In this example, the program code determines, based on the statistics and the calculation described in FIG. 2 (e.g., 220-228), that it should utilize the optimized method and the program code proceeds to generate a filter based on an intersection 630 in the query.

The program code determines the intersection 630 to use to filter the dataset. To this end, the program code fetch predicates datasets (PTJ and PSVL) with a filter. Program code of a Data Virtualization System 654 calculates join results with PTJ and PSVL to generate a filtered dataset FDS in a local engine. The SQL query representing the dataset is: “Select ptj.dept_id, ptj.name from ptj,psvl where ptj.dept_id=psvl.dept_id and ptj.name=psvl.name.” The program code fetches the query datasets (QTJ and QSVL) with filtered values in the filtered dataset FDS in the local engine. The program code calculates final query results with QTJ and QSVL in the local engine as “Select QTJ.dept_id, QTJ.name, type,Rev, . . . from QTJ, QSVL where QTJ.dept_id=QSVL.name.” Through this process, the program code queries the TJ DB 661 with the statements: 1) “Select dept_id, name from bj where (dept_id between 2345 and 2400) and (name between ‘Bill’ and ‘Kat’)” and 2) “Select dept_id, name, rev from tj, FDS where bj.dept_id=FDS.dept_id and svl.name=FDS.name.” The program code queries the SVL DB 671using the statements: 1) “Select dept_id,name from svl where (dept_id between 2345 and 2401) and (name between ‘Bill’ and ‘Kily’); and 2) “Select dept_id,name,type, . . . from svl, FDS where svl.dept_id=FDS.dept_id and svl.name=FDS.name.”

Embodiments of the present invention include computer-implemented method, computer systems, and computer program products where program code executed by one or more processors obtains a query comprising a JOIN statement, where the JOIN statement references two or more tables in the one or more remote databases. The program code determines, for each table of the two or more tables, whether executing the JOIN statement utilizes system resources above a pre-defined allotment. Based on determining, for at least one table of the two or more tables, that executing the JOIN statement utilizes the system resources above the pre-defined allotment, the program code generates a filter for the at least one table based on an intersection between predicates in the query. The program code applies the filter to the at least one table to fetch results for the query and exclude unrelated data from the fetching, wherein the results comprise a filtered dataset.

In some examples, the program code returns query results.

In some examples, the program code applying the filter comprises the program code applying results of the JOIN statement, and the program code returning the query results further comprises: the program code fetching a dataset for predicate columns in the query and a dataset for the JOIN statement, and the program code merging the dataset for the predicate columns in the query and for the dataset for the JOIN statement with the filtered results to produce the query results.

In some examples, the program code determining whether executing the JOIN statement utilizes system resources above a pre-defined threshold comprises: for each table of the two or more tables: the program code obtaining statistics related to the table, based on a portion of the statistics and pre-defined system limits, the program code determining if the table is small table, based on determining that the table is not a small table, the program code utilizing the statistics to calculate a compression ratio; based on the compression ratio being less than or equal to a threshold value, the program code determining that fetching a full dataset from the table utilizes the system resources above the pre-defined allotment.

In some examples, based on the program code determining that the table is small table, the program code fetches an unfiltered dataset from the table.

In some examples, the statistics related to the table comprise a size of a fetched dataset from the table responsive to the query, central processing unit usage in a local host of the table in the system, and bandwidth to transmit the fetched dataset to a data adaptor in the local database host.

In some examples, the portion of the statistics the statistics related to the table comprise parameters of columns referenced in the JOIN statement.

In some examples, the parameters of the columns are selected from the group consisting of: quantile distribution, average length, and column cardinality.

In some examples, the program code generating the filter comprises: the program code determining, based on the query, that the query does not comprise constants in a predicate list of the query, and the program code generating the filter based on the intersection, wherein the intersection comprises an intersection between ranges of the predicates via a quantile distribution.

In some examples, the program code generating the filter comprises: the program code determining that the query comprises constant predicates in a predicate list of the query, and the program code generating the filter based on the intersection, where the intersection comprises an intersection between ranged of all the predicates via quantile distribution.

In some examples, the one or more remote databases comprise at least two databases.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

1. A computer-implemented method of planning and executing a query with a JOIN statement in one or more remote databases, the method comprising:
obtaining, by one or more processors, the query comprising the JOIN statement, wherein the JOIN statement references two or more tables in the one or more remote databases;
for each table of the two or more tables:
obtaining, by the one or more processors, statistics related to the table;
based on the statistics related to the table, determining, by the one or more processors, whether executing the JOIN statement utilizes system resources above a pre-defined allotment;
based on determining, for at least one table of the two or more tables, that executing the JOIN statement utilizes the system resources above the pre-defined allotment, generating, by the one or more processors, a filter for the at least one table based on an intersection between predicates in the query; and
applying, by the one or more processors, the filter, to the at least one table to fetch results for the query and exclude unrelated data from the fetching, wherein the results comprise a filtered dataset.

2. The computer-implemented method of claim 1, further comprising:
returning, by the one or more processors, query results.

3. The computer-implemented method of claim 2, wherein applying the filter comprises applying results of the JOIN statement, and wherein the returning the query results further comprises:
fetching, by the one or more processors, a dataset for predicate columns in the query and a dataset for the JOIN statement; and
merging, by the one or more processors, the dataset for the predicate columns in the query and for the dataset for the JOIN statement with the filtered results to produce the query results.

4. The computer-implemented method of claim 1, wherein the determining whether executing the JOIN statement utilizes system resources above a pre-defined threshold comprises:
for each table of the two or more tables:
based on a portion of the statistics and pre-defined system limits, determining, by the one or more processors, if the table is a small table;
based on determining that the table is not a small table, utilizing, by the one or more processors, the statistics to calculate a compression ratio;
based on the compression ratio being less than or equal to a threshold value, determining that fetching a full dataset from the table utilizes the system resources above the pre-defined allotment.

5. The computer-implemented method of claim 4, further comprising:
based on determining that the table is small table, fetching, by the one or more processors, an unfiltered dataset from the table.

6. The computer-implemented method of claim 4, wherein the statistics related to the table comprise a size of a fetched dataset from the table responsive to the query, central processing unit usage in a local host of the table in the system, and bandwidth to transmit the fetched dataset to a data adaptor in the local database host.

7. The computer-implemented method of claim 4, wherein the portion of the statistics the statistics related to the table comprise parameters of columns referenced in the JOIN statement.

8. The computer-implemented method of claim 7, wherein the parameters of the columns are selected from the group consisting of: quantile distribution, average length, and column cardinality.

9. The computer-implemented method of claim 1, wherein generating the filter comprises:
determining, by the one or more processors, based on the query, that the query does not comprise constants in a predicate list of the query; and
generating, by the one or more processors, the filter based on the intersection, wherein the intersection comprises an intersection between ranges of the predicates via a quantile distribution.

10. The computer-implemented method of claim 1, wherein generating the filter comprises:
determining, by the one or more processors, based on the query, that the query comprises constant predicates in a predicate list of the query; and
generating, by the one or more processors, the filter based on the intersection, wherein the intersection comprises an intersection between ranges of all the constant predicates via quantile distribution.

11. The computer-implemented method of claim 1, wherein the one or more remote databases comprise at least two databases.

12. A computer system for planning and executing a query with a JOIN statement in one or more remote databases, the computer system comprising:
a memory; and
one or more processors in communication with the memory, wherein the computer system is configured to perform a method, said method comprising:
obtaining, by the one or more processors, the query comprising the JOIN statement, wherein the JOIN statement references two or more tables in the one or more remote databases;
for each table of the two or more tables:
obtaining, by the one or more processors, statistics related to the table;
based on the statistics related to the table, determining, by the one or more processors, whether executing the JOIN statement utilizes system resources above a pre-defined allotment;
based on determining, for at least one table of the two or more tables, that executing the JOIN statement utilizes the system resources above the pre-defined allotment, generating, by the one or more processors, a filter for the at least one table based on an intersection between predicates in the query; and
applying, by the one or more processors, the filter, to the at least one table to fetch results for the query and exclude unrelated data from the fetching, wherein the results comprise a filtered dataset.

13. The computer system of claim 12, further comprising:
returning, by the one or more processors, query results.

14. The computer system of claim 13, wherein applying the filter comprises applying results of the JOIN statement, and wherein the returning the query results further comprises:
fetching, by the one or more processors, a dataset for predicate columns in the query and a dataset for the JOIN statement; and
merging, by the one or more processors, the dataset for the predicate columns in the query and for the dataset for the JOIN statement with the filtered results to produce the query results.

15. The computer system of claim 12, wherein the determining whether executing the JOIN statement utilizes system resources above a pre-defined threshold comprises:
for each table of the two or more tables:
based on a portion of the statistics and pre-defined system limits, determining, by the one or more processors, if the table is small table;
based on determining that the table is not a small table, utilizing, by the one or more processors, the statistics to calculate a compression ratio;
based on the compression ratio being less than or equal to a threshold value, determining that fetching a full dataset from the table utilizes the system resources above the pre-defined allotment.

16. The computer system of claim 15, further comprising:
based on determining that the table is small table, fetching, by the one or more processors, an unfiltered dataset from the table.

17. The computer system of claim 15, wherein the statistics related to the table comprise a size of a fetched dataset from the table responsive to the query, central processing unit usage in a local host of the table in the system, and bandwidth to transmit the fetched dataset to a data adaptor in the local database host.

18. The computer system of claim 15, wherein the portion of the statistics the statistics related to the table comprise parameters of columns referenced in the JOIN statement.

19. The computer system of claim 18, wherein the parameters of the columns are selected from the group consisting of: quantile distribution, average length, and column cardinality.

20. A computer program product for planning and executing a query with a JOIN statement in one or more remote databases, the computer program product comprising:
one or more computer readable storage media and program instructions collectively stored on the one or more computer readable storage media readable by at least one processing circuit to:
obtain, by the one or more processors, the query comprising the JOIN statement, wherein the JOIN statement references two or more tables in the one or more remote databases;
for each table of the two or more tables:
obtaining statistics related to the table;
based on the statistics related to the table, determine, by the one or more processors, whether executing the JOIN statement utilizes system resources above a pre-defined allotment;
based on determining, for at least one table of the two or more tables, that executing the JOIN statement utilizes the system resources above the pre-defined allotment, generate, by the one or more processors, a filter for the at least one table based on an intersection between predicates in the query; and
apply, by the one or more processors, the filter, to the at least one table to fetch results for the query and exclude unrelated data from the fetching, wherein the results comprise a filtered dataset.
